(19) United States
(12) Patent Application Publication
(10) Pub. No.: US 2023/0337679 A1
(43) Pub. Date: Oct. 26, 2023

(54) A METHOD FOR CONTROLLING FIELD INSECTS

(71) Applicant: MURDOCH UNIVERSITY, Murdoch (AU)

(72) Inventors: Manjree Agarwal, Kardinya (AU); YongLin Ren, Kardinya (AU); Xin Du, Shelley (AU); Hamish McKirdy, Salter Point (AU)

(21) Appl. No.: 18/023,858

(22) PCT Filed: Aug. 19, 2021
(86) PCT No.: PCT/AU2021/050917

§ 371 Date: Feb. 28, 2023

(30) Foreign Application Priority Data
Sep. 1, 2020 (AU) 2020903117

(51) Int. Cl. A01N 59/00; A01P 7/04; A01N 25/12

(52) U.S. Cl. CPC A01N 59/00; A01P 7/04; A01N 25/12

(57) ABSTRACT

A method of killing insects on or around an intact plant, comprising the step of depositing or suspending in the air a composition comprising synthetic amorphous silica (SAS) on or around the intact plant.

### FIELD OF THE INVENTION

The present invention relates to methods of controlling larvae, nymph and adult insect pests in an outdoor environment using synthetic amorphous silicas.

### BACKGROUND TO THE INVENTION

Members of the fruit fly family Tephritidae are recognised as one of the most serious pests of horticultural production and trade. The Tephritidae contains approximately 4500 species distributed throughout the tropical, sub-tropical and temperate regions of the world and fruit fly species impact production of vegetable and fruits worldwide.

Locusts belong to the Acrididae family of grasshoppers. The desert locust (Schistocerca gregaria), found in various parts of Africa, Asia, and the Middle East, is considered the most destructive migratory pest in the world, with devastating impacts on crops, pasture and fodder.

Pests in the Noctuidae family, in particular Lepidoptera such as fall armyworm (FAW), cotton ballworm, cabbage moth and related species, are major threats to standing crops. Recently an incursion of FAW moth has been detected across multiple regions in Australia. FAW are known to damage more than 350 plant species, including maize, sorghum, corn, fruits, and vegetables, and has devastated crops throughout South-East Asia.

Mosquitoes (Family: Culicidae), are a significant risk to human health and safety. They are the source of many diseases including dengue, malaria, Ross River fever, yellow fever, Zika etc. Controlling mosquitoes and the diseases they transmit is still a major challenge globally.

There are four main classes of insecticides used to control insects such as locust swarms and mosquitoes are organochlorines, organophosphates, carbamates and synthetic pyrethroids.

The organochlorines are highly persistent and include dieldrin and HCH. These insecticides were historically the most favoured for insect control because of their efficacy, cost and persistence. However, they are now considered to be a very high safety risk to human health and the environmental. Organophosphates and carbamates have a moderate range of persistence and speed of action. Synthetic pyrethroids have a rapid effect on the behaviour of insects, but are prone to the development of insect resistance, contamination of soils, groundwater and crop products and health risks to those who apply the pyrethroids.

Considering the control methods presently available, there is a need for more effective, safe and economical insecticides and methods for the treatment of crops and plants, or at least commercial alternatives.

### SUMMARY OF THE INVENTION

The present invention provides a method of killing insects on or around an intact plant comprising the step of:
i. depositing or suspending in the air a composition comprising synthetic amorphous silica (SAS) on or around the intact plant.

Preferably the insect is an insect pest of plants, humans or animals. Preferably the insect to be killed is able to fly in its adult form.

Preferably the intact plant is in an outdoor environment (including glasshouses). The outdoor environment may include a sporting oval, animal yard, or in and around a shed (opened or closed). The SAS may also be deposited or suspended in the air in areas with few intact plants, in order to kill insects that are pests of humans or animals.

The present invention provides a method of killing insects on or around an intact plant, comprising the step of:
i. depositing or suspending in the air a composition comprising hydrophilic synthetic amorphous silica on or around the intact plant;
ii. depositing or suspending in the air a composition comprising hydrophobic synthetic amorphous silica on or around the intact plant; or
iii. depositing or suspending in the air a composition comprising a mixture of hydrophilic synthetic amorphous silica and hydrophobic synthetic amorphous silica on or around the intact plant.

The present invention further provides a composition for use in a method of killing insects on or around an intact plant, wherein the composition comprises:
a) hydrophilic synthetic amorphous silica (SAS);
b) hydrophobic synthetic amorphous silica (SAS); or
c) a mixture of hydrophilic SAS and hydrophobic SAS
and wherein the composition is deposited or suspended in the air on or around the intact plant.

In another aspect, the present invention provides a kit for killing insects on or around an intact plant, wherein the kit comprises:
i. synthetic amorphous silica (SAS); and
ii. instructions for use
wherein the composition is deposited or suspended in the air on or around the intact plant.

The present invention provides a kit for killing insects on or around an intact plant, wherein the kit comprises:
i. synthetic amorphous silica (SAS) chosen from the list comprising:
   a) hydrophilic synthetic amorphous silica (SAS);
   b) hydrophobic synthetic amorphous silica (SAS); or
   c) a mixture of hydrophilic SAS and hydrophobic SAS; and
ii. instructions for use
wherein the composition is deposited or suspended in the air on or around the intact plant.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1: Image of fruit flies and crickets in mesh boxes.

FIG. 2: Diagram showing positioning of mesh bags and mesh boxes in the fume hood.

FIG. 3: Diagram showing positioning of mesh bags and mesh boxes in the shipping container.

FIG. 4: Effect of ambient relative humidity on mortality of Medfly treated with different ratios of HB9 to HP8.

FIG. 5: Image of treatment of cabbage moth larvae.

FIG. 6: Image of treatment of fall armyworm larvae.

FIG. 7: Image of treated cabbage moth larvae.

FIG. 8: Image of treated fall armyworm larvae.

### DESCRIPTION OF INVENTION

### Detailed Description of the Invention

### Method for Killing Insects

Synthetic amorphous silica has been used as an agent for controlling insect pests in harvested and stored grains, as described in AU2015234233. However, this use is on post-harvest crops within controlled indoor environments such as a silo or within bagged food products, where air flow is controlled, and the humidity is maintained at a constant low level.

The present invention has surprisingly found that synthetic amorphous silica (SAS) can be used to control insects, including flying insects, in an open environment or environment where air flow and humidity is variable and uncontrolled, or at least less controlled than in a silo or within bagged food products.

According to a first aspect, the present invention provides a method of killing insects on or around an intact plant, comprising the step of:
i. depositing or suspending in the air a composition comprising synthetic amorphous silica (SAS) on or around the intact plant.

By “intact plant”, it is meant a plant that is growing. The plant may be a broadacre crop, vegetable crop, fruit crop, tree plantation, pot plant, ornamental garden, park etc. The term does not include post-harvest grains, fruits, etc. The term encompasses plants which may be harvested at a later date, but which at the time of application of the SAS are growing. Intact plants may include plants that have been trimmed, mowed, pruned etc.; the term “intact” refers to the plant as an entire entity, not to a product that can be harvested from the plant.

Preferably the intact plant is in an outdoor environment. By the term “outdoor environment” it is meant an environment that is outside a warehouse, silo, or other structure for storage of harvested products. It also excludes environments inside bags, packages, boxes etc. An external environment is one that it not human controlled in relation to air flow (e.g. wind), humidity, rainfall, amount of light etc. or is at least less controlled than in a silo or within bagged food products. The outdoor environment may include a glasshouse, which is not entirely outdoors, but is subject to airflow and varying humidity. The outdoor environment may include one that does not contain large numbers of plants, but which is used by humans for recreational activities or which contains animals that are irritated by the insects These areas include sporting ovals, parks, the yards or balconies of houses, pig farms, chicken coops and poultry houses, and stagnant water bodies which are breeding places for mosquitoes.

Preferably, the insects are insects present on plants or associated with plants. The plants may be crops, pot plants, plantations, forests, lawns etc. Thus, the insects to be killed by the method of the present invention are insects that fly around plants, crawl on plants, burrow into plants, exist on and in the soil around plants or swamp areas. Preferably the insects are pests of plants, including pests of crops, pot plants, trees etc. Alternatively, the insects may be insects present in the outdoor environment that are pests to animals and humans, such as flies, mosquitoes and darkling beetles. Insects that may be treated by the present invention include flies, fruit flies, mosquitos, moths and butterflies, beetles and locusts. The methods of the present invention can be used to control a range of insects. For the purposes of the present invention the term “insect(s)” is taken to include related pests such as arachnids, including mites and spiders. Similarly, the term “insecticide” extends to agents that are active against these other pests that are not strictly insects.

Preferably, the insects are flying insects, more preferably flying insect pests. This refers to insects that in their adult form use flight to move from place to place. The method of the present invention will work if it contacts such flying insects while in flight but will also work to kill flying insects once either the SAS or the insect has settled on a surface such as a leaf or soil surface.

By the term “pest” it is meant that the insect causes damage to plants, particularly economically significant plants such as broad acre crops, vegetables, plantation trees. The pest may be an insect that causes damage to plants with personal or community value, such as pot plants and plants in gardens and parks. The insect pest may inflict damage that reduces the value of a plant crop, reduces the growth rate of a plant crop, reduces the fruiting or seed-bearing capacity of a plant crop, reduces the flowering of a plant etc. The damage that the insect pest does may be damage to the plant either before or during production of a commercial product.

The term “pest” also includes insects that cause damage and discomfort to humans and animals. These pests may not be present in outdoor environments that contain large numbers of plants; however, the insect pests cause irritation to humans and animals. These insect pests include pests that are found in parks, the yards or balconies of houses, chicken coops and chicken houses, and pig farms.

The method for killing insect pests in the present invention is not a method for killing insects in post-harvest crops (grain, seed, pulse, etc) or processed foods (flour, packaged seed or grain etc).

It is surprising that the method for killing insects using SAS of the present invention works to kill insects in uncontrolled outdoor environments (including greenhouses). In such environments, administration of the SAS is affected by factors such as air flow (wind); the humidity of the air and soil; the moisture content of the leaves; and the large volume of space to which the SAS is distributed.

It is known that the ability of hydrophilic SAS to kill an insect can decrease if the hydrophilic SAS is wetted. In contrast, the ability of hydrophobic SAS to kill an insect is not affected if the hydrophobic SAS is applied to a wetted environment

The silica can be blown or otherwise circulated in the air to cover a desired area. For example, the SAS may be blown from a blower as dust in a chicken house or greenhouse, applied over a crop or tree plantation via a crop duster, shaken from a packet over a pot plant, or other method that introduces the fine particles of SAS to the air around a plant and allows the SAS to settle on the plant and surrounding soil.

The silica may be aerated. When the silica is aerated it may be suspended in a carrier fluid or gas, such as air, nitrogen, carbon dioxide or fumigant gas.

Preferably the SAS is suspended in the air at a rate of between 0.1-20 g/cm³, 0.25-15 g/cm³ or 0.5-10 g/cm³. The SAS may be applied at a rate of at least 0.1 g/cm³, 0.2 g/cm³, 0.3 g/cm³, 0.4 g/cm³, 0.5 g/cm³, 0.6 g/cm³, 0.7 g/cm³, 0.8 g/cm³, 0.9 g/cm³, 1 g/cm³, 2 g/cm³, 3 g/cm³, 4 g/cm³, 5 g/cm³, 6 g/cm³, 7 g/cm³, 8 g/cm³, 9 g/cm³, or 10 g/cm³. Preferably the SAS is applied at between 0.5-10 g/cm³.

Preferably the SAS is deposited on a surface such as a plant leaf, soil etc at a rate of between 0.1-5 g/cm², 0.5-3 g/cm², or 1-2 g/cm². The SAS may be applied at a rate of at least 0.1 g/cm², 0.2 g/cm², 0.3 g/cm², 0.4 g/cm², 0.5 g/cm², 0.6 g/cm², 0.7 g/cm², 0.8 g/cm², 0.9 g/cm², 1 g/cm², 1.5 g/cm², 2 g/cm², 2.5 g/cm², 3 g/cm², 3.5 g/cm², 4 g/cm², 4.5 g/cm², or 5 g/cm². Preferably the SAS is applied at between 1-2 g/cm².

For the purposes of the present invention the term “synthetic” means non-naturally occurring amorphous silica. The synthetic amorphous silica of the present invention excludes naturally occurring amorphous silica such as diatomaceous earth. The synthetic amorphous silica (SAS) may be produced by standard thermal route (pyrogenic/fumed) or wet route (precipitated, gel, colloidal) processes.

Preferably, the synthetic amorphous silica comprises a solid such as a particulate solid. The synthetic amorphous silica may comprise a dust or powder.

By “amorphous” it is meant that the SAS is a solid that lacks the long-range order that is characteristic of a crystal. Amorphous silica is non-crystalline silica that does not contain quartz glass or fused quartz. The lack of crystalline silica reduces the danger of inhaled silica causing silicosis.

It is preferred that the SAS of the present invention comprises less than 0.5%, 0.4%, 0.3%, 0.2% or 0.1% crystalline silica, more preferably less than 0.09%, 0.08%, 0.07%, 0.06%, 0.05%, 0.04%, 0.03%, 0.02% or 0.01% crystalline silica.

In another form of the invention, the synthetic amorphous silica can be surface modified for different application purposes. The SAS may be hydrophilic SAS or may be treated to generate hydrophobic SAS. For example, by coating hydrophilic SAS (e.g. HP8) with silicon oil, a hydrophobic SAS can be made (e.g. HB9) (Table 1).

The present invention provides a method of killing insects on or around an intact plant, comprising the step of:
i. depositing or suspending in the air a composition comprising hydrophilic synthetic amorphous silica on or around the intact plant.

The present invention provides a method of killing insects on or around an intact plant, comprising the step of:
i. depositing or suspending in the air a composition comprising hydrophobic synthetic amorphous silica on or around the intact plant.

The present invention provides a method of killing insects on or around an intact plant, comprising the step of:
i. depositing or suspending in the air a composition comprising a mixture of hydrophilic synthetic amorphous silica and hydrophobic synthetic amorphous silica on or around the intact plant.

Preferably, if a mixture of hydrophilic synthetic amorphous silica and hydrophobic synthetic amorphous silica is used, the ratio of hydrophilic SAS to hydrophobic SAS is between 99.9:0.1 and 0.1:99.9. For example, the ratio may be between 99:1 and 1:99, 80:20 to 20:80, 75:25 to 25:75, 60:40 to 40:60. The ratio may be 99.9:0.1, 99:1, 80:20, 75:25, 60:40, 50:50, 0.1:99.9, 1:99, 20:80, 25:75, or 40:60. The ratio of hydrophilic to hydrophobic SAS suitable for application depends on the moisture content of the surface and the relative humidity of the air at the time of application.

Preferably, the synthetic amorphous silica comprises at least 91%, 92%, 93%, 94%, 95%, 96%, 97%, 98% or 99% silica, by weight.

Preferably, the synthetic amorphous silica is “food grade” insofar as it is suitable for consumption without undue adverse effects. Even more preferably, the synthetic amorphous silica meets the food grade certifications from at least one of the following regulatory bodies: Food Chemical Codex (FCC), US Food and Drugs Administration (USFDA), Australian Inventory of Chemical Substances (AICS), Canadian Food Inspection Agency (CFIA). Alternatively or in addition, the synthetic amorphous silica may be on at least one of the following inventories: European Inventory of Existing Commercial chemical Substances (EINECS), Japan ENCS Inventory and the USA TSCA Chemical Substance Inventory.

Preferably, the composition used in the methods of the present invention contains less than 1% of contaminants from the list comprising: alumina, iron oxide, unreacted sodium silicate, aluminium salt or ammonium fluosilicate. Preferably, the composition contains no contaminants from the list comprising: alumina, iron oxide, unreacted sodium silicate, aluminium salt or ammonium fluosilicate

Preferably, the synthetic amorphous silica is the only insecticide in the composition.

The synthetic amorphous silica may comprise between 70-99.9% of the composition. For example, the SAS may comprise between 70-99.9%, 80-99.9%, 90-99.9%, or 70-90%, or 80-90% of the composition. The SAS may comprise at least 70%, 75%, 80%, 85%, 90%, 95% or 99% of the composition.

The composition may comprise active agrochemical compounds other than one or more active compounds of the invention.

The composition may further comprise one or more of the following auxiliary components: inert carrier(s), surface active agent(s) such as a sticker or spreader, stabilizer(s) and/or dye(s). The compositions may also be suspended in a carrier fluid, such as air, nitrogen, carbon dioxide or fumigant gas. The compositions preferably comprise auxiliaries such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the composition, without the component itself having a biological effect. Examples of adjuvants are agents which promote the retention, spreading, attachment to the leaf surface, or penetration of the SAS into the insect. Generally speaking, the active compounds may be combined with any solid or liquid additive commonly used for formulation purposes.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic or pseudoplastic thickeners), in-container microbial growth (antimicrobials), product freezing (antifreezes), colour (dyes/pigment dispersions), wash-off (film formers or sticking agents), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes.

The components other than the SAS (e.g. auxiliary components, other active agents, carrier fluids) may comprise less than 30% of the compositions of the present invention. The components other than the SAS may compromise 29%, 25%, 20%, 15%, 10%, 5%, 2.5%, 1% or 0.1% of the composition.

The compositions of the present invention are produced in a known manner, for example by mixing the active compounds with auxiliaries such as extenders, solvents and/or solid carriers and/or further auxiliaries, such as surfactants. The compositions are prepared either in suitable manufacturing plants or else before or during the application.

Preferably, the synthetic amorphous silica has an average particle size of less than 20000 nm, more preferably less than 10000 nm and even more preferably less than 1000 nm. It is particularly preferred for the synthetic amorphous silica to have an average particle size of less than 750, 500 or 250 nm. In one form of the invention the average particle of the synthetic amorphous silica is 50-200 nm, 100-150 nm or 110-120 nm. Preferably the average particle of the synthetic amorphous silica is between 50-200 nm.

Preferably, the synthetic amorphous silica has an effective surface area of at least 50 m²/g, 75 m²/g, 100 m²/g, 110 m²/g, 125 m²/g or 150 m²/g. In one form of the invention the synthetic amorphous silica has an effective surface area of 185-280 m²/g.

Preferably, the effective surface area according to the present invention is determined according to the BET technique.

Preferably, the synthetic amorphous silica has an oil absorption value of at least at least 50 ml/100 g, 75 ml/100 g, 100 ml/100 g, 125 ml/100 g, 150 ml/100 g, 175 ml/100 g, 200 ml/100 g or 250 ml/100 g. In one form of the invention the synthetic amorphous silica has an oil absorption value of 290-320 ml/100 g.

Preferably, the synthetic amorphous silica is adapted to generate a net negative charge on a substance to which it is applied. Preferably, the net negative charge is between −0.003 and −0.1. In one form of the invention the net negative charge is at least −0.09, −0.08, −0.07, −0.05, −0.025 or −0.01.

The methods of the present invention can kill insects by introducing the SAS onto the insect as it flies through the air, by introducing the SAS onto the insect as it crawls on the plant or soil, or by the insect coming into contact with SAS deposited on the plant or soil or suspended in the air.

The methods of the present invention can be used to control a range of invertebrate pests. For example, the compositions may be used to control insects belonging to the Tephritidae, Acrididae, Noctuidae, Tenebrionidae and Culicidae families. Preferably, the flying agriculture and human pests which are controlled by the methods of the present invention are chosen from the list comprising: fruit flies, locust, fall armyworm, cotton ballworm, mosquitoes, darkling beetles and related species in agriculture, horticultural, forest, urban or suburban areas.

The methods of the present invention may be used to kill insects on food crops, broad acre crops and vegetable and fruit crops in the field, orchard, vineyard and nursery; and on plants in domestic garden settings and pot plants and lawns, sporting ovals etc. The SAS of the present invention may also be used to kill insects in intensive plant growth situations such as greenhouses. The methods of the present invention may be used to kill insects in situations with few plants, but high levels of insect pests, such as mosquitoes and flies in backyards, around pig farms, chicken coops and chicken houses, and barns.

The methods of the present invention may be used to kill insects in their larval stage, pupal (nymph) stage or adult stage.

### Compositions for Killing Insects

In another aspect, the present invention provides a composition for use in a method of killing insects on or around an intact plant, wherein the composition comprises synthetic amorphous silica (SAS) and wherein the composition is deposited or suspended in the air on or around the intact plant.

The present invention further provides a composition for use in a method of killing insects on or around an intact plant, wherein the composition comprises:
a) hydrophilic synthetic amorphous silica (SAS);
b) hydrophobic synthetic amorphous silica (SAS); or
c) a mixture of hydrophilic SAS and hydrophobic SAS
and wherein the composition is deposited or suspended in the air on or around the intact plant.

Preferably, the synthetic amorphous silica is the only insecticide in the composition.

The compositions may comprise one or more of the following components: inert carrier(s), surface active agent(s) such as a sticker or spreader, stabilizer(s) and/or dye(s). The compositions may also be suspended in a carrier fluid, such as air, nitrogen, carbon dioxide or fumigant gas.

Preferably, the mixture of hydrophilic synthetic amorphous silica and hydrophobic synthetic amorphous silica is used in a ratio of hydrophilic SAS to hydrophobic SAS of between 99.9:0.1 and 0.1:99.9. For example, the ratio may be between 99:1 and 1:99, 80:20 to 20:80, 75:25 to 25:75, 60:40 to 40:60. The ratio may be 99.9:0.1, 99:1, 80:20, 75:25, 60:40, 50:50, 0.1:99.9, 1:99, 20:80, 25:75, or 40:60.

The synthetic amorphous silica may comprise at least 70%-99.9% of the composition. It is preferred that the SAS of the present invention comprises less than 0.5%, 0.4%, 0.3%, 0.2% or 0.1% crystalline silica.

Preferably the SAS is suspended in the air at a rate of between 0.1-20 g/cm³, 0.25-15 g/cm³ or 0.5-10 g/cm³. Preferably the SAS is deposited on a surface such as a plant leaf, soil etc at a rate of between 0.1-5 g/cm², 0.5-3 g/cm², or 1-2 g/cm².

Preferably, the synthetic amorphous silica has an average particle size of less than 20000 nm, more preferably less than 10000 nm and even more preferably less than 1000 nm. Preferably, the synthetic amorphous silica has an effective surface area of at least 50 m²/g, 75 m²/g, 100 m²/g, 110 m²/g, 125 m²/g or 150 m²/g. Preferably, the synthetic amorphous silica has an oil absorption value of at least at least 50 ml/100 g. Preferably, the synthetic amorphous silica is adapted to generate a net negative charge on a substance to which it is applied of between −0.003 and −0.1.

### Kits

In another aspect, the present invention provides a kit for killing insects on or around an intact plant, wherein the kit comprises:
ii. synthetic amorphous silica (SAS); and
iii. instructions for use
wherein the composition is deposited or suspended in the air on or around the intact plant.

The present invention provides a kit for killing insects on or around an intact plant, wherein the kit comprises:
i. synthetic amorphous silica (SAS) chosen from the list comprising:
   a) hydrophilic synthetic amorphous silica (SAS);
   b) hydrophobic synthetic amorphous silica (SAS); or
   c) a mixture of hydrophilic SAS and hydrophobic SAS; and
ii. instructions for use
wherein the composition is deposited or suspended in the air on or around the intact plant. The kit comprises the composition as described above and is used in a method as described above.

### General

Those skilled in the art will appreciate that the invention described herein is susceptible to variations and modifications other than those specifically described. The invention includes all such variation and modifications. The invention also includes all of the steps, features, compositions and compounds referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

Any manufacturer's instructions, descriptions, product specifications, and product sheets for any products mentioned herein or in any document incorporated by reference herein, are hereby incorporated herein by reference, and may be employed in the practice of the invention.

The present invention is not to be limited in scope by any of the specific embodiments described herein. These embodiments are intended for the purpose of exemplification only. Functionally equivalent products, compositions and methods are clearly within the scope of the invention as described herein.

The invention described herein may include one or more range of values (eg. Size, displacement and field strength etc). A range of values will be understood to include all values within the range, including the values defining the range, and values adjacent to the range which lead to the same or substantially the same outcome as the values immediately adjacent to that value which defines the boundary to the range. Accordingly, unless indicated to the contrary, the numerical parameters set forth in the specification and claims are approximations that may vary depending upon the desired properties sought to be obtained by the present invention. Hence “about 80%” means “about 80%” and also “80%”. At the very least, each numerical parameter should be construed in light of the number of significant digits and ordinary rounding approaches.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs. The term “active agent” may mean one active agent or may encompass two or more active agents.

The following examples serve to more fully describe the manner of using the above-described invention, as well as to set forth the best modes contemplated for carrying out various aspects of the invention. It is understood that these methods in no way serve to limit the true scope of this invention, but rather are presented for illustrative purposes.

### Examples

Further features of the present invention are more fully described in the following non-limiting Examples. This description is included solely for the purposes of exemplifying the present invention. It should not be understood as a restriction on the broad description of the invention as set out above.

### Example 1—Generation of Synthetic Amorphous Silicas (SAS) Powder

### Materials/Methods

### SAS Products

Basic reference (source) details of the dusts used in the examples are summarised in Table 1.

TABLE 1
Basic reference and source details of SAS products

| SAS | SAS | | |
|---|---|---|---|
| Identifier | products | Made from | Processing methods |
| HP4^{#} | Pirosil | sodium silicate (water | Wet synthesis * |
| | PS 200 | glass) | |
| HP7 | BT-30 | sodium silicate (water | Wet/thermal synthesis ** |
| | | glass) | |
| HP8 | BT-40A | sodium silicate (water | Wet/thermal synthesis |
| | | glass) | |
| HB9^{##} | BT-386 | sodium silicate (water | Wet/thermal synthesis |
| | | glass) | and surface modified |

^{#}Hydrophilic (HP)
^{##}Hydrophobic (HB)
* Wet method includes precipitated and/or aerogel method
** Thermal method includes thermal and/or pyrogenic and/or fumed methods

### Methods

To better characterise each SAS powder, the electrostatic charges were neutralised using a static gun (Proscitech) and then each SAS powder was adsorbed to sticky carbon tape and photographed using a scanning electron microscope (Phillips XL 20, Eindhoven, Netherlands) at scales of 1 um, 500 nm and 20 nm.

From the 1 μm micrograph 4 particle spots were randomly selected and measured for length and breadth. Same or similar spots were measured using the 500 nm micrograph. The measurements were converted to nm units using the scale at the base of electron micrograph and means and standard deviations were calculated. Each SAS powder product was analysed in duplicate.

### Results

The SAS powder in Table 1 were characterised according to a range of parameters (see Table 2).

TABLE 2
SAS powder characteristics

| | | BET | DBP | | |
|---|---|---|---|---|---|
| | | surface | absorption | | |
| SAS | Particle | area* | (ml/100 g | Food | Hydrophilic/ |
| Identifier | Size (nm) | (m²/g) | dust) | grade | phobic |
| HP4 | <114.2 | 185 | 290 | Yes | Hydrophilic |
| HP7 | <116.4 | 260-280 | 310 | Yes | Hydrophilic |
| HP8 | <117.8 | ≥260 | 320 | Yes | Hydrophilic |
| HB9 | <116.8 | 260-280 | 300 | No | Hydrophobic |

*Named after the authors of the theory Brunauer, Emmett and Teller. BET is a widely used technique for the calculation of effective surface area using adsorption and to explain the physical adsorption of gas on solid surface

### Example 2—Efficacy of SAS Powder Against Mediterranean Fruit Flies (Medfly) and House Crickets

### Materials/Methods

### SAS Powder

SAS powders HP4, HP7, HP8, and HB9 and combinations of HB9:HP8 (99.9:0.1), HB9:HP8 (50:50), and HB9:HP8 (0.1:99.9) from Example 1 were tested for efficacy.

### Insects

Ceratitis capitata Mediterranean fruit flies, also known as Medfly (Family: Tephritidae), were taken from the colony managed by the National Centre for Post-harvest Disinfestation Research on Mediterranean Fruit Fly (Australian Medfly R&D Centre), Murdoch University, Western Australia. Approximately 10-day old adults were used.

Acheta domesticus house crickets (Order: Acrididae) were collected from north of Western Australia and kept in 1 L plastic take away containers with meshed lids at 25° C. and 60% relative humidity with dried twigs leaves, empty pieces of egg carton and water until use. Male and female adult crickets and male and female 8th instar nymphs were used. Crickets were used in this study as they belong to the same order (Acrididae) as locusts.

### Specification of Treatments Bags and Chamber

Mesh bags were made of nylon/muslin or any material which can allow SAS powder to pass through but prevents insects from escaping. Size 15 cm×15 cm.

Cloth meshed cubes with zip: Mesh cube were made up of nylon/muslin or any material which can allow SAS powder to pass but prevents insects escaping. Size 30×30×30 cm.

Specification of the application chamber where the bags or boxes were kept:
1. Sealed fumehood: 1.5 m (height)×1.5 m (width)×1.0 m (length).
2. Sealed shipping container: 22 ft shipping container of dimension 6 m (length)×2.4 m (height)×2 m (width)

### Methodology

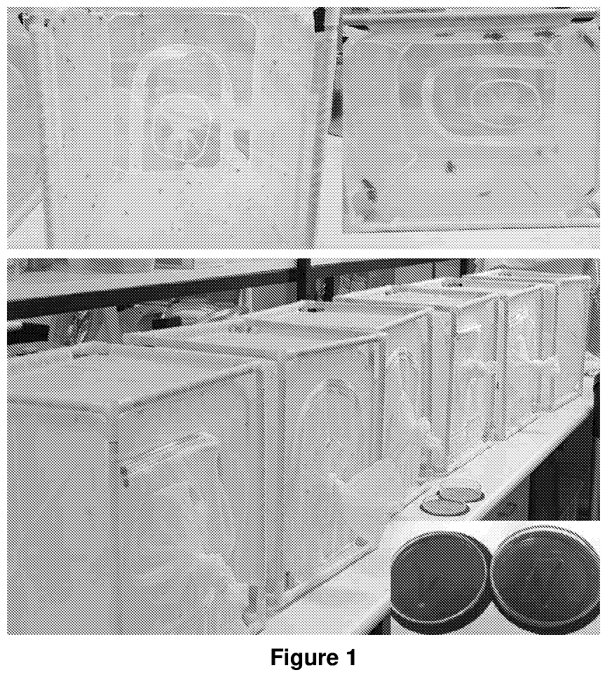

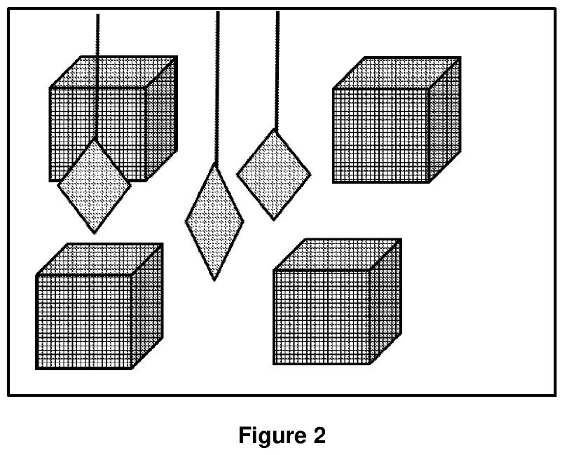

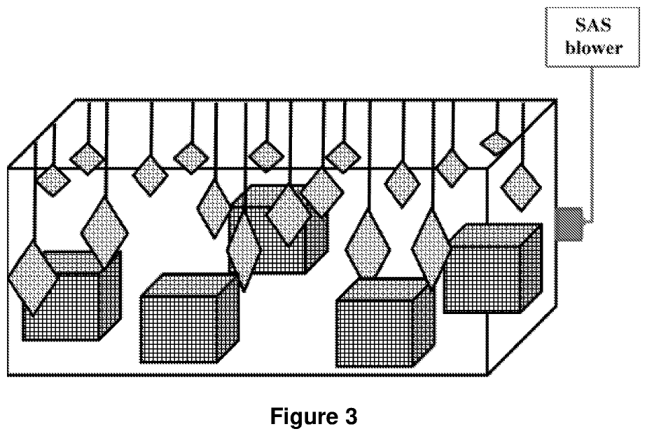

On the day of treatment, insects were added into the bags/cages with (i) one adult per bag for crickets, (ii) 10 to 15 adults or nymphs per box for crickets, or (iii) about 50 to 70 mixed gender fruit fly adults per box (FIG. 1). The bags and cages were placed in a shipping container or a fumehood application chamber as per FIGS. 2 and 3. Each mesh bag and mesh cage was given a specific ID. Once the bags/cages were placed in the application chamber (shipping container or fumehood), the application chamber was sealed thoroughly. For the fumehood, this was a PVC sheet adhered to the fumehood after closing the front shield. A small hole, allowing only the nozzle of the blower to fit through, was left open for application of SAS. Similarly, after placing the bags and cages in the shipping container the door of the shipping container was sealed with a modified applicator inserted in between the door seals. The SAS powder or its composition was applied from the blower by placing its nozzle on the modified applicator.

As a control treatment, the same number of bags and boxes with the same number of insects were kept outside the application chamber. For the fumehood application, the control bags and boxes were kept outside of the fumehood on a benchtop. For the shipping container application, the controls were kept in another shipping container maintained at the same temperature and humidity.

For application of SAS powder, consideration was given to the volume of the SAS powder per second through the SAS powder blower (0.5-5.0 g/sec). A low blowing rate and long application time was used to generate a diffuse cloud and fine covering of SAS, to avoid flocculation or agglomeration of the SAS powder. A short interval pulsed application can also be done. The volume of the application chamber was 10 m³ and the total amount of SAS applied was 6 g.

Mortality assessment: The mesh bags and mesh boxes were collected 24 hrs after treatment. The mortality of the insects in each mesh bag was evaluated immediately after collection.

### Results

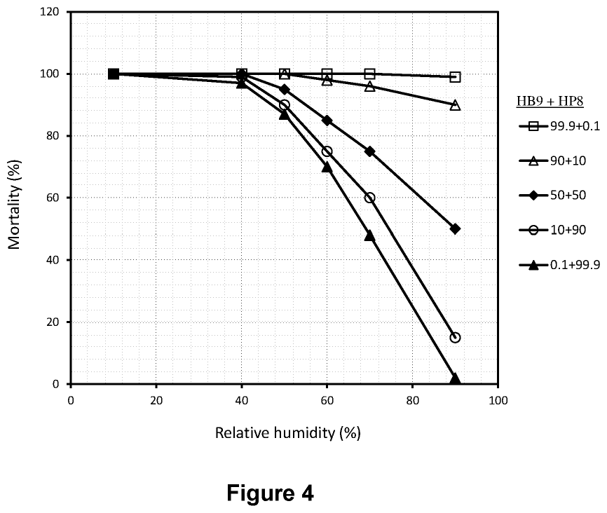

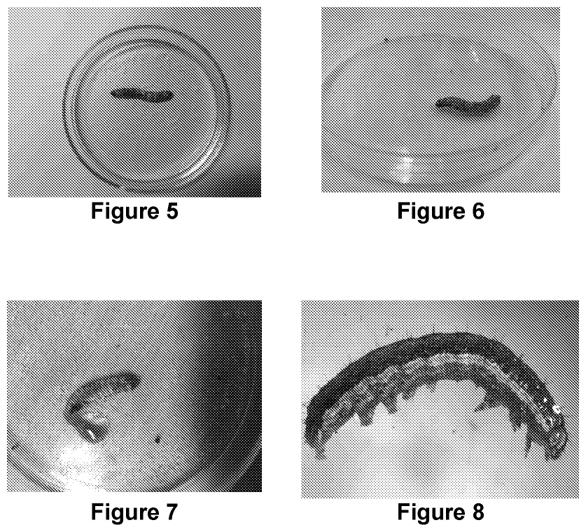

For HP4 and HP7, mortality between 97.5% and 99% was observed for both Medflies and crickets. For HP8 and HB9, 100% mortality was observed within 24 hours for both the insects in both the fumehood and the shipping container (Table 3 and FIG. 4).

TABLE 3
Mortality data for medflies and cricket in fumehood
and shipping container treatment chamber

| | Mortality (%) | | Mortality (%) Shipping | |
|---|---|---|---|---|
| | Fumehood treatment | | container treatment | |
| SAS powder | Medflies | Cricket | Medflies | Cricket |
| HP4 | 98 | 97.5 | 99 | 98 |
| HP7 | 99 | 99 | 99.5 | 97.5 |
| HP8 | 100 | 100 | 100 | 100 |
| HB9 | 100 | 100 | 100 | 100 |
| HB9:HP8 (99.9:0.1) | 100 | 100 | 100 | 100 |
| HB9:HP8 (50:50) | 100 | 100 | 100 | 100 |
| HB9:HP8 (0.1:99.9) | 100 | 100 | 100 | 100 |

### Example 3—Effect of Humidity on Killing of Medfly by SAS Powder

### Materials/Methods

The same methodology as for Example 2 was used to treat Medlfy. However, the relative humidity of the air inside the application chamber was modified in a range between 10% and 90%.

Ratios of HP8 to HB9 of between 99.9:0.1 and 0.1:99.9 were tested. As HP8 is hydrophilic and HB9 is hydrophobic, relative humidity will have different effects depending on the relative amount of each SAS powder (FIG. 4).

### Results

Results are shown in FIG. 4. Hydrophilic SAS HP8 absorbs moisture when the relative environmental humidity is increased, leading to a reduce mortality or efficacy for insect killing. Relative environmental humidity has no effect on the ability of hydrophobic SAS HB9 to kill insects. For example, when HB9:HP8 was 99.9:0.1, 90:10, 50:50 10:90 and 0.1:99.9, the fruit fly mortality of was 100%, 90%, 50%, 17% and 4%. thus when there is a predominance of hydrophilic HP8 in the composition, fruit fly mortality is reduced in humid conditions, but if there is a predominance of hydrophobic HB9 in the composition, the fruit fly mortality remains high.

### Example 4—Efficacy of SAS Powder Against Lepidopteran Agriculture Pests of Family Noctuidae

### Materials/Methods

The effect of SAS powders HP8 and HB9 from Example 1 was further tested on the larvae of cabbage moth (Mamestra brassicae) and the larvae of fall armyworm (Spodoptera frugiperda).

Larvae were added to 9 cm glass petri dish and SAS powders HP8 and HB9 were added at the rate of 1-2 g/m2 and left undisturbed for 24 hours (FIG. 6—M. brassicae; FIG. 7—S. frugiperda).

### Results

Both HP8 and HB9 can kill larvae effectively (FIG. 8—M. brassicae; FIG. 9—S. frugiperda).

1. A method of killing insects on or around an intact plant, comprising the step of:
i. depositing or suspending in the air a composition comprising synthetic amorphous silica (SAS) on or around the intact plant.

2. The method of claim 1 wherein the insect to be killed is able to fly in its adult form.

3. The method of claim 1 wherein the insect to be killed is a member of a Family chosen from the list comprising: Tephritidae, Acrididae, Noctuidae, Tenebrionidae and Culicidae.

4. The method of claim 1 wherein the intact plants are in an outdoor environment.

5. The method of claim 1 wherein the SAS is chosen from the list comprising:
a) hydrophilic synthetic amorphous silica (SAS);
b) hydrophobic synthetic amorphous silica (SAS); or
c) a mixture of hydrophilic SAS and hydrophobic SAS.

6. The method of claim 1 wherein the SAS has one or more of the following features:
a) an average particle size of less than 20000 nm;
b) an effective surface area of at least 50 m²/g;
c) an oil absorption value of at least at least 50 ml/100 g;
d) is adapted to generate a net negative charge on a substance to which it is applied of between −0.003 and −0.1

7. A composition for use in a method of killing insects on or around an intact plant, wherein the composition comprises synthetic amorphous silica (SAS) and wherein the composition is deposited or suspended in the air on or around the intact plant.

8. A kit for killing insects on or around intact plants, wherein the kit comprises:
i. synthetic amorphous silica (SAS); and
ii. instructions for use
wherein the composition is deposited or suspended in the air on or around the intact plant.
